(19) United States
(12) Patent Application Publication
(10) Pub. No.: US 2025/0367930 A1
(43) Pub. Date: Dec. 4, 2025

(54) Liquid Ejection Head And Liquid Ejection Device

(71) Applicant: SEIKO EPSON CORPORATION, Tokyo (JP)

(72) Inventors: Yu SHIOZAWA, Shiojiri (JP); Takahiro KANEGAE, Shiojiri (JP); Yasushi YAMAZAKI, Azumino (JP); Yuzo NEISHI, Suwa (JP); Hitoshi TAKAAI, Azumino (JP); Motoki TAKABE, Shiojiri (JP)

(21) Appl. No.: 19/220,644

(22) Filed: May 28, 2025

(30) Foreign Application Priority Data
May 29, 2024 (JP) 2024-087289

(51) Int. Cl. B41J 2/14

(52) U.S. Cl. CPC B41J 2/14233; B41J 2002/14306

(57) ABSTRACT

the first pressure chamber substrate is provided with a first pressure chamber partitioned by the first portion, the third portion, and the fourth portion, and a second pressure chamber partitioned by the second portion, the third portion, and the fifth portion, the second pressure chamber substrate is provided with a third pressure chamber partitioned by the third portion, the fourth portion, the fifth portion and communicating with the first pressure chamber, the second pressure chamber, and a nozzle, and the piezoelectric element is commonly disposed across the first pressure chamber, the second pressure chamber, and the third pressure chamber.

The present application is based on, and claims priority from JP Application Serial Number 2024-087289, filed May 29, 2024, the disclosure of which is hereby incorporated by reference herein in its entirety.

### BACKGROUND

### 1. Technical Field

The present disclosure relates to a liquid ejection head and a liquid ejection device.

### 2. Related Art

In a liquid ejection head such as a piezoelectric ink jet head, a liquid such as ink is ejected from a nozzle communicating with a pressure chamber as a piezoelectric element changes a pressure in the pressure chamber. For example, JP-A-2023-72166 describes a liquid ejection head in which a communication plate, a pressure chamber substrate, a vibration plate, and a piezoelectric element are stacked in this order. In the liquid ejection head, a part of a nozzle is provided on the communication plate, and a pressure chamber provided in the pressure chamber substrate is disposed directly above the nozzle. In addition, a circulation mechanism for circulating ink flowing through the pressure chamber is coupled to the liquid ejection head.

In a configuration described in JP-A-2023-72166, since the nozzle is disposed directly below the pressure chamber, there is an advantage that a pressure applied by the piezoelectric element is transmitted to the nozzle without loss, so that ejection characteristics can be improved, and a cross-sectional area of the pressure chamber or a flow path in the vicinity of the pressure chamber is reduced by using a thin substrate, and the flow rate is increased, so that thickened ink can be suitably removed. The thickened ink is caused as a viscosity of the ink increases directly above the nozzle because of reduction in a solvent component due to evaporation at a gas-liquid interface of the nozzle.

However, in the configuration described in JP-A-2023-72166, in a flow path resulted from circulation, a space in the communication plate and a space in the pressure chamber substrate are continuous directly above the nozzle, and the cross-sectional area is locally increased, so that a flow rate is locally decreased, and as a result, there is a problem that the thickened ink is not sufficiently removed.

### SUMMARY

According to an aspect of the present disclosure, there is provided a liquid ejection head including: a piezoelectric element; a vibration plate that vibrates through driving of the piezoelectric element; a first pressure chamber substrate; a second pressure chamber substrate; and a nozzle substrate provided with a nozzle that ejects a liquid, the piezoelectric element, the vibration plate, the first pressure chamber substrate, the second pressure chamber substrate, and the nozzle substrate being stacked in a stacking direction from top to bottom in an order of the piezoelectric element, the vibration plate, the first pressure chamber substrate, the second pressure chamber substrate, and the nozzle substrate, in which the first pressure chamber substrate includes a first portion, a second portion separated from the first portion, a third portion separated from the first portion and the second portion and positioned between the first portion and the second portion, the second pressure chamber substrate includes a fourth portion and a fifth portion separated from the fourth portion, the first pressure chamber substrate is provided with a first pressure chamber partitioned by the first portion, the third portion, and the fourth portion, and a second pressure chamber partitioned by the second portion, the third portion, and the fifth portion, the second pressure chamber substrate is provided with a third pressure chamber partitioned by the third portion, the fourth portion, the fifth portion and communicating with the first pressure chamber, the second pressure chamber, and the nozzle, and the piezoelectric element is commonly disposed across the first pressure chamber, the second pressure chamber, and the third pressure chamber.

According to another aspect of the present disclosure, there is provided a liquid ejection device including: the liquid ejection head according the aspect described above; and a control section that controls an ejection operation of the liquid ejection head.

### BRIEF DESCRIPTION OF THE DRAWINGS

FIG. 1 is a schematic diagram illustrating a configuration example of a liquid ejection device according to a first embodiment.

FIG. 2 is an exploded perspective view of a liquid ejection head according to the first embodiment.

FIG. 3 is a cross-sectional view taken along a line III-III in FIG. 2.

FIG. 4 is an enlarged cross-sectional view illustrating a part of the liquid ejection head according to the first embodiment.

FIG. 5 is a cross-sectional view taken along a line V-V in FIG. 4.

FIG. 6 is a cross-sectional view taken along a line VI-VI in FIG. 4.

FIG. 7 is an enlarged cross-sectional view illustrating a part of a liquid ejection head of Comparative Example 1.

FIG. 8 is an enlarged cross-sectional view illustrating a part of a liquid ejection head of Comparative Example 2.

FIG. 9 is an enlarged cross-sectional view illustrating a part of a liquid ejection head of Comparative Example 3.

FIG. 10 is an enlarged cross-sectional view illustrating a part of a liquid ejection head according to a second embodiment.

FIG. 11 is an enlarged cross-sectional view illustrating a part of a liquid ejection head according to a third embodiment.

FIG. 12 is a cross-sectional view taken along a line XII-XII in FIG. 11.

FIG. 13 is an enlarged cross-sectional view illustrating a part of a liquid ejection head according to a fourth embodiment.

FIG. 14 is a cross-sectional view taken along a line XIII-XIII in FIG. 13.

### DESCRIPTION OF EMBODIMENTS

Hereinafter, preferred embodiments according to the present disclosure will be described with reference to the accompanying drawings. In the drawings, dimensions and scale of each portion are appropriately different from actual ones, and some parts are schematically illustrated for easy understanding. In addition, the scope of the present disclosure is not limited to these forms unless it is stated in the following description that the present disclosure is particularly limited.

In the following description, for the sake of convenience, an X axis, a Y axis, and a Z axis that intersect each other are appropriately used. In addition, hereinafter, one direction along the X axis is an X1 direction, and a direction opposite to the X1 direction is an X2 direction. Similarly, directions opposite to each other along the Y axis are a Y1 direction and a Y2 direction. Further, directions opposite to each other along the Z axis are a Z1 direction and a Z2 direction. A Z2 direction side is referred to as “up”, and a Z1 direction side is referred to as “down”. However, a relationship between the Z axis and a vertical direction is not particularly limited, and is optional. The X axis, Y axis, and Z axis are typically orthogonal to each other, but are not limited to this, and need only intersect each other, for example, at an angle within a range of 80° or more and 100° or less.

### 1. First Embodiment

### 1-1. Schematic Configuration of Liquid Ejection Device Including Liquid Ejection Head

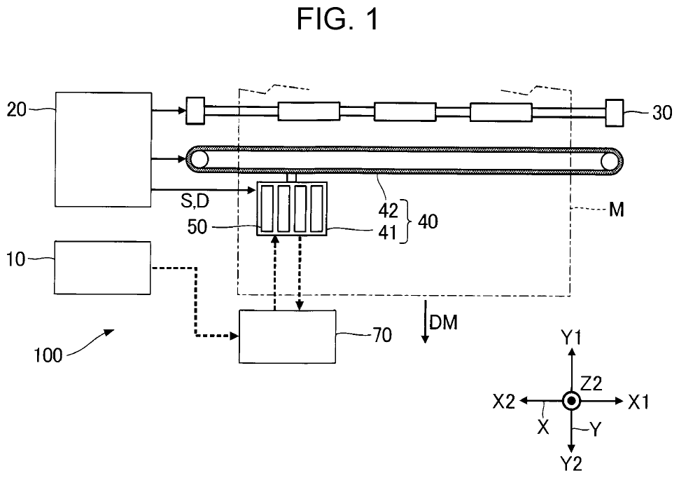

FIG. 1 is a schematic diagram illustrating a configuration example of a liquid ejection device 100 according to a first embodiment. The liquid ejection device 100 is an ink jet printing device that ejects ink, which is an example of a “liquid”, as a droplet to a medium M. The medium M is typically printing paper. The medium M is not limited to the printing paper, and may be, for example, a printing target having any desired material such as a resin film or a cloth.

As illustrated in FIG. 1, the liquid ejection device 100 includes a liquid container 10, a control section 20, a transport mechanism 30, a moving mechanism 40, a plurality of liquid ejection heads 50, and a circulation mechanism 70. Hereinafter, all of these will be briefly described in order with reference to FIG. 1.

The liquid container 10 stores ink. As a specific aspect of the liquid container 10, for example, a cartridge that can be attached to and detached from the liquid ejection device 100, a bag-shaped ink pack formed of a flexible film, and an ink tank that can be refilled with ink may be used. A type of ink to be stored in the liquid container 10 is not particularly limited, and is selected in any desired way.

The control section 20 includes, for example, a processing circuit including one or more processors such as a central processing unit (CPU) or a field-programmable gate array (FPGA), and a storage circuit such as a semiconductor memory, and controls an operation of each element of the liquid ejection device 100.

The transport mechanism 30 transports the medium M in a transport direction DM, which is the Y1 direction, under control of the control section 20. The moving mechanism 40 causes the plurality of liquid ejection heads 50 to reciprocate in the X1 direction and the X2 direction under the control of the control section 20. In the example illustrated in FIG. 1, the moving mechanism 40 includes a substantially box-shaped transport body 41 called a carriage for accommodating the plurality of liquid ejection heads 50, and a transport belt 42 to which the transport body 41 is fixed. The transport body 41 may be provided with the liquid container 10 described above in addition to the plurality of liquid ejection heads 50.

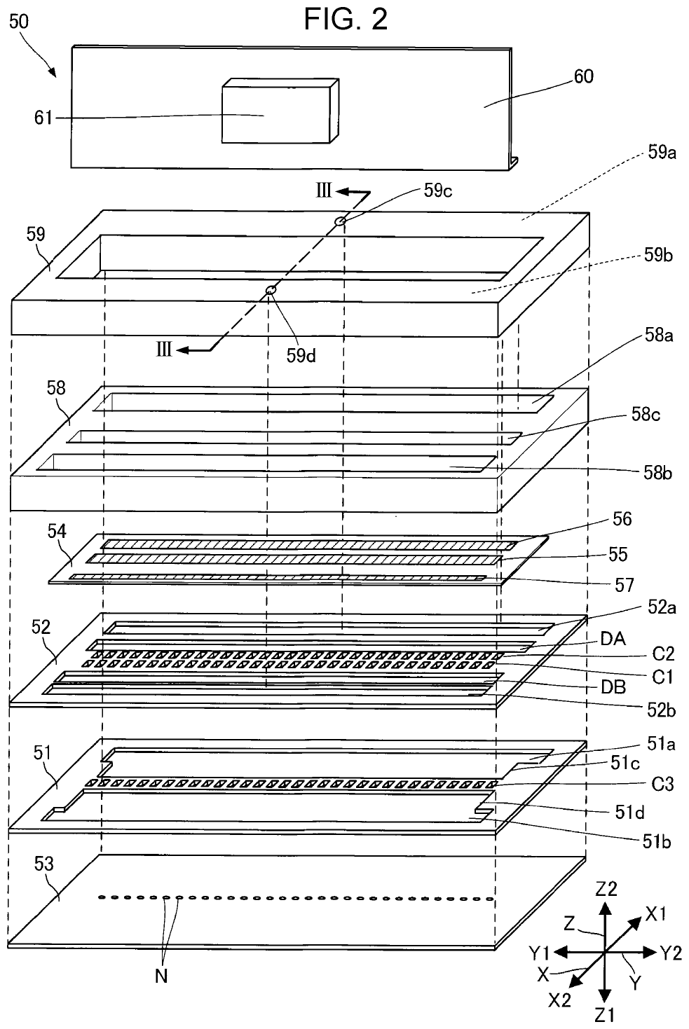

Each of the plurality of liquid ejection heads 50 ejects the ink, which is supplied from the liquid container 10 via the circulation mechanism 70, from each of a plurality of nozzles to the medium M in the Z1 direction under the control of the control section 20. The ejection is performed in parallel with the transport of the medium M via the transport mechanism 30 and reciprocating movement of the liquid ejection head 50 caused by the moving mechanism 40, and thus an image is formed by the ink on a surface of the medium M. Details of the liquid ejection head 50 will be described later with reference to FIGS. 2 to 6. The number of liquid ejection heads 50 included in the liquid ejection device 100 is not limited to the example illustrated in FIG. 1, and may be any number, and may be three or less or five or more, or may be one.

In the example illustrated in FIG. 1, the liquid container 10 is coupled to the plurality of liquid ejection heads 50 via the circulation mechanism 70. The circulation mechanism 70 is a mechanism that supplies the ink to the plurality of liquid ejection heads 50 and collects the ink discharged from the plurality of liquid ejection heads 50 for resupply to the plurality of liquid ejection heads 50. The circulation mechanism 70 includes, although not shown, for example, a supply flow path for supplying the ink to the liquid ejection head 50, a collection flow path for collecting the ink discharged from the liquid ejection head 50, and a pump for generating a pressure for transferring the ink. By the operation of the circulation mechanism 70 as described above, the ink is circulated between each liquid ejection head 50 and the circulation mechanism 70, so that it is possible to reduce an increase in a viscosity of the ink and reduce retention of air bubbles in the ink in each liquid ejection head 50.

As described above, in the liquid ejection device 100, the control section 20 controls an ejection operation of the liquid ejection head 50. Accordingly, reliability and ejection characteristics of the liquid ejection head 50 are superior to those in the related art as described later, and thus it is possible to achieve the liquid ejection device 100 having superior reliability and ejection characteristics.

### 1-2. Liquid Ejection Head

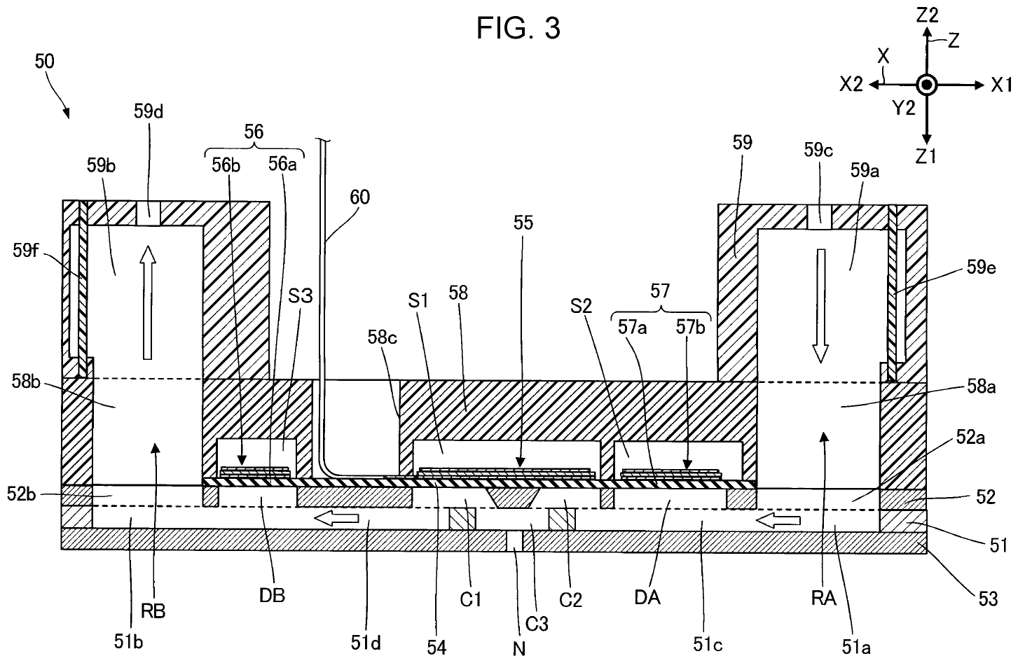

FIG. 2 is an exploded perspective view of the liquid ejection head 50 according to the first embodiment. FIG. 3 is a cross-sectional view taken along a line III-III in FIG. 2. In FIG. 3, a cross section of the liquid ejection head 50 cut along a plane along both the X axis and the Z axis is illustrated.

Schematically, the liquid ejection head 50 is provided with a plurality of nozzles N, reservoirs RA and RB, a plurality of first pressure chambers C1, a plurality of second pressure chambers C2, a plurality of third pressure chambers C3, a plurality of piezoelectric elements 55, an introduction port 59c, and an discharge port 59d. In the following, a set of the first pressure chamber C1, the second pressure chamber C2, and the third pressure chamber C3 may be referred to as a pressure chamber C.

The plurality of nozzles N are arranged along the Y axis. Each of the reservoirs RA and RB is a common liquid chamber that is continuous across the plurality of nozzles N. Each of the pressure chamber C and the piezoelectric element 55 is provided for each nozzle N. Each of the first pressure chamber C1 and the second pressure chamber C2 communicates with the nozzle N via the third pressure chamber C3. Each of the plurality of pressure chambers C is filled with the ink supplied from the reservoir RA. The piezoelectric element 55 changes a pressure of the ink in the pressure chamber C. As the piezoelectric element 55 changes the pressure of the ink in the pressure chamber C, the ink is ejected from the nozzle N.

The introduction port 59c communicates with the reservoir RA. The ink is introduced into the reservoir RA from the circulation mechanism 70 via the introduction port 59c. The ink introduced into the reservoir RA from the introduction port 59c is appropriately used for ejection from each nozzle N. The discharge port 59d communicates with the reservoir RB. The ink that is not ejected from each nozzle N and is stored in the reservoir RB is discharged from the discharge port 59d. The ink discharged from the discharge port 59d is collected by the circulation mechanism 70. In this manner, the ink is circulated between the liquid ejection head 50 and the circulation mechanism 70.

Hereinafter, the configuration of the liquid ejection head 50 will be described in more detail. As illustrated in FIGS. 2 and 3, the liquid ejection head 50 includes a second pressure chamber substrate 51, a first pressure chamber substrate 52, a nozzle substrate 53, a vibration plate 54, the plurality of piezoelectric elements 55, a first absorption member 56, a second absorption member 57, a sealing plate 58, a case 59, a wiring substrate 60, and a drive circuit 61.

In the liquid ejection head 50, the piezoelectric element 55, the vibration plate 54, the first pressure chamber substrate 52, the second pressure chamber substrate 51, and the nozzle substrate 53 are stacked in this order in a stacking direction from the top to the bottom. That is, the piezoelectric element 55, the vibration plate 54, the first pressure chamber substrate 52, the second pressure chamber substrate 51, and the nozzle substrate 53 are stacked in this order in the Z1 direction. Hereinafter, the Z1 direction may be referred to as the “stacking direction”.

Here, the second pressure chamber substrate 51 and the first pressure chamber substrate 52 form a flow path for supplying the ink to the plurality of nozzles N. The vibration plate 54, the plurality of piezoelectric elements 55, the first absorption member 56, the second absorption member 57, the sealing plate 58, the case 59, the wiring substrate 60, and the drive circuit 61 are installed in a region positioned in the Z2 direction with respect to a stacked body consisting of the second pressure chamber substrate 51 and the first pressure chamber substrate 52. Meanwhile, the nozzle substrate 53 is installed in a region positioned in the Z1 direction with respect to the stacked body. Each element of the liquid ejection head 50 is joined to each other by, for example, an adhesive or direct bonding.

The plurality of nozzles N are provided on the nozzle substrate 53. Each of the plurality of nozzles N is a through-hole through which the ink passes, and ejects the ink as the piezoelectric element 55 is driven. The nozzle substrate 53 is manufactured by processing a silicon single crystal substrate by, for example, a semiconductor manufacturing technology using a processing technology such as dry etching or wet etching. Note that other known methods and materials may be appropriately used for manufacturing the nozzle substrate 53. Further, a cross-sectional shape of the nozzle N is typically a circular shape, but the shape is not limited thereto, and may be, for example, a non-circular shape such as a polygonal or elliptical shape. In addition, a width of the nozzle N may not be constant.

The second pressure chamber substrate 51 is provided with flow paths 51a and 51b, a common supply flow path 51c, a common discharge flow path 51d, and the plurality of third pressure chambers C3. The flow path 51a and the common supply flow path 51c are elongated openings extending in a direction along the Y axis in a plan view viewed in a direction along the Z axis, and communicate with each other. The flow path 51b and the common discharge flow path 51d are elongated openings extending in the direction along the Y axis in a plan view viewed in the direction along the Z axis, and communicate with each other. Each of the plurality of third pressure chambers C3 is a through-hole formed for each nozzle N.

The first pressure chamber substrate 52 is provided with the plurality of first pressure chambers C1, the plurality of second pressure chambers C2, a first absorption chamber DB, a second absorption chamber DA, and flow paths 52a and 52b. The plurality of first pressure chambers C1 are respectively provided for nozzles N and are arranged in the direction along the Y axis. Similarly, the plurality of second pressure chambers C2 are respectively provided for nozzles N and are arranged in the direction along the Y axis. Each of the first pressure chambers C1 and each of the second pressure chambers C2 is an elongated space extending in the direction along the X axis in a plan view. The second pressure chamber C2 is disposed at a position in the X1 direction with respect to the first pressure chamber C1. Each of the flow path 52a, the flow path 52b, the first absorption chamber DB, and the second absorption chamber DA is commonly provided for the plurality of nozzles N, and is an elongated opening extending in the direction along the Y axis in a plan view viewed in the direction along the Z axis. The flow path 52a overlaps the flow path 51a in a plan view and communicates with the flow path 51a. The flow path 52b overlaps the flow path 51b in a plan view and communicates with the flow path 51b. The first absorption chamber DB is disposed between the first pressure chamber C1 and the flow path 52b. The second absorption chamber DA is disposed between the second pressure chamber C2 and the flow path 52a.

Each of the second pressure chamber substrate 51 and the first pressure chamber substrate 52 is manufactured by processing a silicon single crystal substrate by, for example, a semiconductor manufacturing technology, similarly to the nozzle substrate 53 described above. Meanwhile, other known methods and materials may be appropriately used for manufacturing each of the second pressure chamber substrate 51 and the first pressure chamber substrate 52. A thickness of each of the second pressure chamber substrate 51 and the first pressure chamber substrate 52 is not particularly limited, and is preferably 50 μm or more and 100 μm or less.

The second pressure chamber C2 communicates with each of the third pressure chamber C3 and the common supply flow path 51c. Therefore, the second pressure chamber C2 communicates with the nozzle N via the third pressure chamber C3 and communicates with the flow path 51a via the common supply flow path 51c. Meanwhile, the first pressure chamber C1 communicates with each of the third pressure chamber C3 and the common discharge flow path 51d. Therefore, the first pressure chamber C1 communicates with the nozzle N via the third pressure chamber C3 and communicates with the flow path 51b via the common discharge flow path 51d. As described above, the first pressure chamber C1, the second pressure chamber C2, and the nozzle N communicate with the third pressure chamber C3.

Here, each of the first pressure chamber C1, the second pressure chamber C2, and the third pressure chamber C3 extends in an extending direction along the X axis. In addition, a plurality of sets of the first pressure chamber C1, the second pressure chamber C2, and the third pressure chamber C3 are arranged in an arrangement direction (Y-axis direction) intersecting the extending direction.

As described above, the liquid ejection head 50 includes the common supply flow path 51c and the common discharge flow path 51d. The common supply flow path 51c supplies ink to the plurality of sets of the first pressure chamber C1, the second pressure chamber C2, and the third pressure chamber C3 in common. Meanwhile, the common discharge flow path 51d discharges the ink from the plurality of sets of the first pressure chamber C1, the second pressure chamber C2, and the third pressure chamber C3 in common. By providing the common supply flow path 51c and the common discharge flow path 51d in this manner, it is possible to smoothly supply a liquid from the common supply flow path 51c to one pressure chamber among the first pressure chamber C1 and the second pressure chamber C2 of each set, and to smoothly discharge a liquid from the other pressure chamber to the common discharge flow path 51d.

In addition, as described above, the liquid ejection head 50 includes the first absorption chamber DB and the second absorption chamber DA. The first absorption chamber DB is a space that communicates with the first pressure chamber C1 and absorbs a pressure caused by the piezoelectric element 55. Meanwhile, the second absorption chamber DA is a space that communicates with the second pressure chamber C2 and absorbs a pressure caused by the piezoelectric element 55. By providing the first absorption chamber DB and the second absorption chamber DA as described above, unnecessary vibration of the liquid in the first pressure chamber C1 and the second pressure chamber C2 can be reduced. As a result, the ejection characteristics can be improved.

Here, the first absorption chamber DB overlaps the common discharge flow path 51d in a plan view. Therefore, the common discharge flow path 51d also functions as a space for absorbing the pressure caused by the piezoelectric element 55, similarly to the first absorption chamber DB. As described above, the first absorption chamber DB is formed with a space in the first pressure chamber substrate 52 and a space in the second pressure chamber substrate 51. Similarly, the second absorption chamber DA overlaps the common supply flow path 51c in a plan view. Therefore, the common supply flow path 51c also functions as a space for absorbing the pressure caused by the piezoelectric element 55, similarly to the second absorption chamber DA. As described above, the second absorption chamber DA is formed with a space in the first pressure chamber substrate 52 and a space in the second pressure chamber substrate 51. In the first absorption chamber DB and the second absorption chamber DA having the above configurations, a volume of each of the first absorption chamber DB and the second absorption chamber DA can be increased. As a result, unnecessary vibration of the liquid in the first pressure chamber C1 and the second pressure chamber C2 can be suitably reduced.

The vibration plate 54 is disposed on a surface of the first pressure chamber substrate 52 facing the Z2 direction. The vibration plate 54 is a plate-shaped member configured to elastically vibrate, and vibrates through driving of the piezoelectric element 55. For example, the vibration plate 54 includes a first layer and a second layer, and the first layer and the second layer are stacked in this order in the Z1 direction. For example, the first layer is an elastic film made of silicon oxide (SiO₂). The elastic film is formed, for example, by thermally oxidizing one surface of a silicon single crystal substrate. The second layer is, for example, an insulating film made of zirconium oxide (ZrO₂). The insulating film is formed, for example, by forming a zirconium layer by a sputtering method and thermally oxidizing the layer. The vibration plate 54 is not limited to the above-described configuration of stacking the first layer and the second layer. For example, the vibration plate 54 may be formed of a single layer, or may be formed of three or more layers.

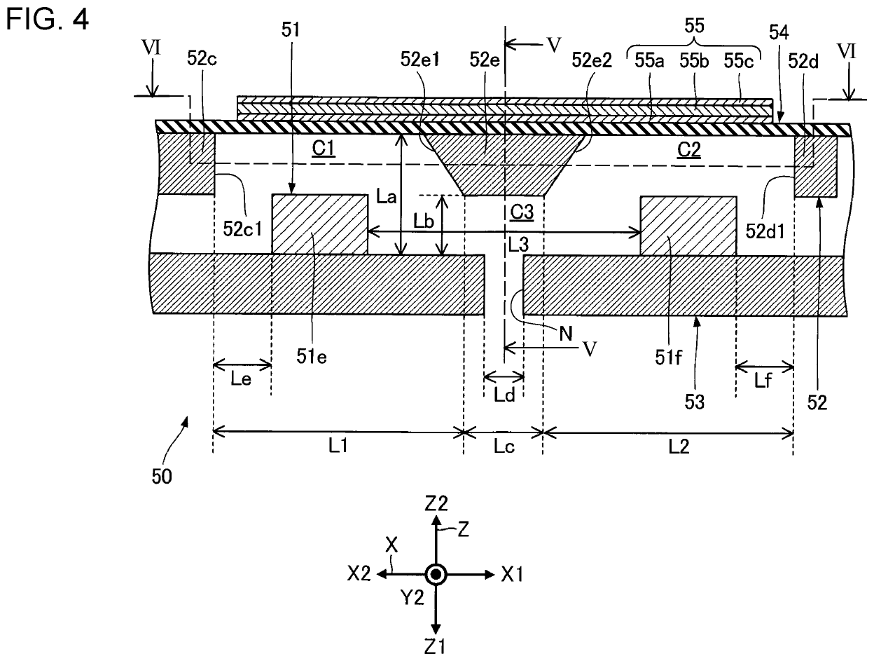

The plurality of piezoelectric elements 55 are disposed on a surface of the vibration plate 54 facing the Z2 direction. Each of the piezoelectric elements 55 is a passive element that is deformed by supply of a drive signal. Each of the piezoelectric elements 55 has an elongated shape extending in the direction along the X axis in a plan view. The plurality of piezoelectric elements 55 are respectively provided for nozzles N and are arranged in the direction along the Y axis. Each piezoelectric element 55 is commonly provided across the corresponding first pressure chamber C1 and second pressure chamber C2. That is, each piezoelectric element 55 extends across and overlaps the corresponding first pressure chamber C1 and second pressure chamber C2 in a plan view. The configuration of the piezoelectric element 55 will be described later with reference to FIGS. 4 to 6.

The first absorption member 56 is a vibration absorbing body that is provided above the first absorption chamber DB and absorbs a change in a pressure of the ink in the first absorption chamber DB. The first absorption member 56 includes a compliance substrate 56a and a weight 56b.

The compliance substrate 56a is a flexible plate-shaped member disposed on the surface of the first pressure chamber substrate 52 facing the Z2 direction to cover the first absorption chamber DB. The compliance substrate 56a forms an upper wall of the first absorption chamber DB. In the example illustrated in FIG. 3, the compliance substrate 56a is formed integrally with the vibration plate 54. Therefore, the compliance substrate 56a has the same layer configuration as the vibration plate 54.

The weight 56b is a mass body disposed on a surface of the compliance substrate 56a facing the Z2 direction. By providing the weight 56b as described above, a resonance frequency and the like of the first absorption member 56 can be adjusted. In the example illustrated in FIG. 3, the weight 56b has the same layer configuration as the piezoelectric element 55.

As described above, the first absorption member 56 is formed of the same material as at least a part of the vibration plate 54 and the piezoelectric element 55. Accordingly, the first absorption member 56 can be implemented while reducing the manufacturing cost. The compliance substrate 56a may be separate from the vibration plate 54, or may have a layer configuration different from that of the vibration plate 54. In addition, the weight 56b may have a layer configuration different from that of the piezoelectric element 55.

The second absorption member 57 is a vibration absorbing body that is provided above the second absorption chamber DA and absorbs a change in a pressure of the ink in the second absorption chamber DA. The second absorption member 57 includes a compliance substrate 57a and a weight 57b.

The compliance substrate 57a is a flexible plate-shaped member disposed on the surface of the first pressure chamber substrate 52 facing the Z2 direction to cover the second absorption chamber DA. The compliance substrate 57a forms an upper wall of the second absorption chamber DA. In the example illustrated in FIG. 3, the compliance substrate 57a is formed integrally with the vibration plate 54. Therefore, the compliance substrate 57a has the same layer configuration as the vibration plate 54.

The weight 57b is a mass body disposed on a surface of the compliance substrate 57a facing the Z2 direction. By providing the weight 57b as described above, a resonance frequency and the like of the second absorption member 57 can be adjusted. In the example illustrated in FIG. 3, the weight 57b has the same layer configuration as the piezoelectric element 55.

As described above, the second absorption member 57 is formed of the same material as at least a part of the vibration plate 54 and the piezoelectric element 55. Accordingly, the second absorption member 57 can be implemented while reducing the manufacturing cost. The compliance substrate 57a may be separate from the vibration plate 54, or may have a layer configuration different from that of the vibration plate 54. In addition, the weight 57b may have a layer configuration different from that of the piezoelectric element 55.

The sealing plate 58 is a plate-shaped member installed on the surface of the vibration plate 54 facing the Z2 direction, and protects the plurality of piezoelectric elements 55, the first absorption member 56, and the second absorption member 57, and reinforces mechanical strength of the vibration plate 54. The sealing plate 58 is made of, for example, a resin material. A plurality of recessed portions for forming sealing spaces S1, S2, and S3 are provided on a surface of the sealing plate 58 facing the Z1 direction. The plurality of piezoelectric elements 55 are accommodated in the sealing space S1. The second absorption member 57 is accommodated in the sealing space S2. The first absorption member 56 is accommodated in the sealing space S3.

In addition, the sealing plate 58 is provided with flow paths 58a and 58b and a wiring hole 58c. Each of the flow paths 58a and 58b is commonly provided for the plurality of nozzles N, and is an elongated opening extending in the direction along the Y axis in a plan view viewed in the direction along the Z axis. The flow path 58a overlaps the flow path 52a in a plan view and communicates with the flow path 52a. The flow path 58b overlaps the flow path 52b in a plan view and communicates with the flow path 52b. The wiring hole 58c is a through-hole for the wiring substrate 60 to pass through, and extends in the direction along the Y axis in a plan view viewed in the direction along the Z axis.

The case 59 is a case for storing the ink to be supplied to the plurality of pressure chambers C. The case 59 is made of, for example, a resin material. The case 59 is provided with flow paths 59a and 59b, the introduction port 59c, the discharge port 59d, and compliance substrates 59e and 59f.

The flow path 59a is a space communicating with the flow path 52a described above, and functions as the reservoir RA that stores the ink supplied to the plurality of pressure chambers C together with the flow paths 51a and 52a. The reservoir RA communicates with the second pressure chamber C2 via the common supply flow path 51c. Meanwhile, the flow path 59b is a space communicating with the flow path 52b described above, and functions as the reservoir RB that stores the ink discharged from the plurality of pressure chambers C together with the flow paths 51b and 52b. The reservoir RB communicates with the first pressure chamber C1 via the common discharge flow path 51d.

The compliance substrate 59e is a flexible plate-shaped member forming a part of a wall surface of the flow path 59a, and absorbs a change in a pressure of the ink in the reservoir RA. Meanwhile, the compliance substrate 59f is a flexible plate-shaped member forming a part of a wall surface of the flow path 59b, and absorbs a change in a pressure of the ink in the reservoir RB. Each of the compliance substrates 59e and 59f is made of, for example, a resin film, and is fixed to a main body of the case 59 by an adhesive or the like. In the example illustrated in FIG. 3, a compliance space, which is a space for allowing deformation of the compliance substrates 59e and 59f, is provided between the main body and the compliance substrates 59e and 59f, and each of the compliance substrates 59e and 59f is not exposed to an outside of the case 59. Each of the compliance substrates 59e and 59f may be exposed to the outside of the case 59. In addition, each of the compliance substrates 59e and 59f is provided as necessary, and may be omitted.

The wiring substrate 60 is a mounted component that is mounted on the surface of the vibration plate 54 facing the Z2 direction, and electrically couples the control section 20 and the liquid ejection head 50. The wiring substrate 60 is, for example, a flexible wiring substrate such as a chip on film (COF), a flexible printed circuit (FPC), or a flexible flat cable (FFC). The drive circuit 61 for supplying a drive voltage to each piezoelectric element 55 is mounted on the wiring substrate 60 of the present embodiment. The drive circuit 61 is a circuit that performs switching based on a control signal S as to whether or not to supply at least a part of a waveform in a drive signal D as a drive pulse.

### 1-3. First Pressure Chamber, Second Pressure Chamber, and Third Pressure Chamber

Hereinafter, the first pressure chamber C1, the second pressure chamber C2, and the third pressure chamber C3 will be described in detail with reference to FIGS. 4 to 7.

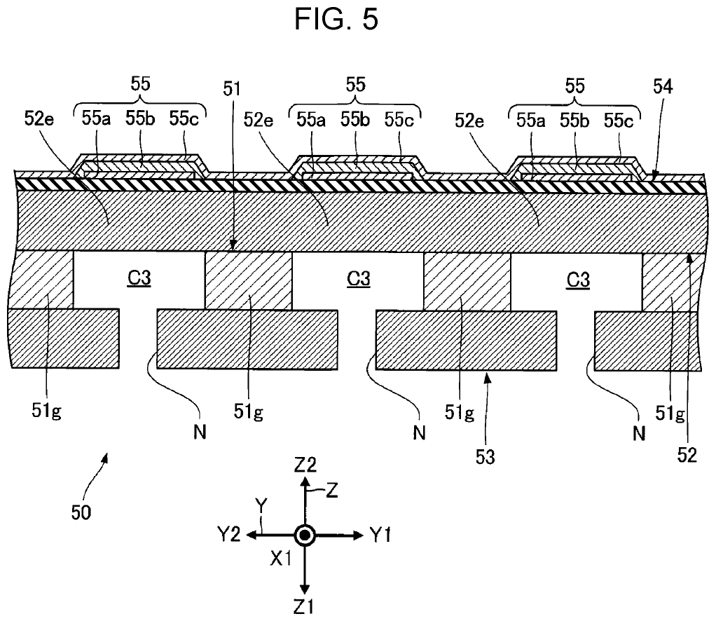

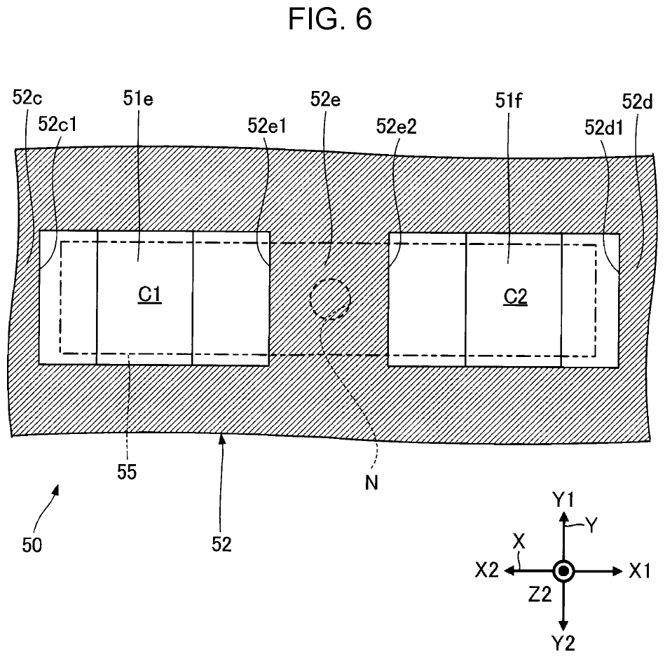

FIG. 4 is an enlarged cross-sectional view illustrating a part of the liquid ejection head 50 according to the first embodiment. FIG. 5 is a cross-sectional view taken along a line V-V in FIG. 4. FIG. 6 is a cross-sectional view taken along a line VI-VI in FIG. 4. In FIG. 4, a part of the cross section illustrated in FIG. 3 is illustrated.

First, the piezoelectric element 55 will be described before the first pressure chamber C1, the second pressure chamber C2, and the third pressure chamber C3 are described.

As illustrated in FIG. 5, each of the piezoelectric elements 55 includes a first electrode 55a, a piezoelectric layer 55b, and a second electrode 55c, and these are stacked in this order in the Z2 direction. The first electrodes 55a are individual electrodes respectively disposed for the piezoelectric elements 55 to be separated from each other, and a drive voltage of the drive signal D is applied to the first electrodes. The drive voltage is a voltage that changes with time. The second electrode 55c is a band-shaped common electrode that extends in the direction along the Y axis to be continuous across the plurality of piezoelectric elements 55, and a reference voltage of the drive signal D is supplied to the second electrode. The reference voltage is a voltage that is constant regardless of time, and a value slightly higher than a ground voltage is set, for example. The reference voltage may be supplied to the first electrode 55a as a common electrode, and the drive voltage may be supplied to the second electrode 55c as an individual electrode. In any case, a voltage corresponding to a difference between the drive voltage and the reference voltage is applied to the piezoelectric layer 55b. Examples of a metal material of the electrodes include metal materials such as platinum (Pt), aluminum (Al), nickel (Ni), gold (Au), and copper (Cu), and among the materials, one type may be used alone or two or more types may be used in combination in an alloyed or stacked manner. The piezoelectric layer 55b is made of a piezoelectric material such as lead zirconate titanate (Pb(Zr, Ti) 03), and is individually provided for each piezoelectric element 55, for example. When the vibration plate 54 vibrates in conjunction with the deformation of the piezoelectric element 55 described above, the pressure in the first pressure chamber C1 and the second pressure chamber C2 changes, and the pressure in the third pressure chamber C3 changes accordingly, so that the ink is ejected from the nozzle N.

The piezoelectric element 55 described above is commonly disposed across the first pressure chamber C1, the second pressure chamber C2, and the third pressure chamber C3. Accordingly, a size of the liquid ejection head 50 can be reduced in the direction along the X axis.

Here, as illustrated in FIG. 4, the first pressure chamber substrate 52 includes a first portion 52c, a second portion 52d, and a third portion 52e. The first portion 52c, the third portion 52e, and the second portion 52d are separated from each other and are disposed in this order in the X1 direction. As described above, the second portion 52d is separated from the first portion 52c. Further, the third portion 52e is separated from the first portion 52c and the second portion 52d, and is positioned between the first portion 52c and the second portion 52d. Meanwhile, the second pressure chamber substrate 51 includes a fourth portion 51e and a fifth portion 51f. The fourth portion 51e and the fifth portion 51f are separated from each other and are disposed in this order in the X1 direction. As described above, the fifth portion 51f is separated from the fourth portion 51e.

As described above, an upper portion of the third pressure chamber C3 communicating with the nozzle N is partitioned by the third portion 52e of the first pressure chamber substrate 52, so that a cross-sectional area of a flow path from one of the first pressure chamber C1 and the second pressure chamber C2 to the other via the third pressure chamber C3 can be reduced directly above the nozzle N. The cross-sectional area of the flow path referred to in the present embodiment is a cross-sectional area of the flow path directly above the nozzle N when viewed from an X-axis direction, and has widths in the Y-axis direction and a Z-axis direction. Among these, according to the present embodiment, the width in the Z-axis direction can be kept within a thickness Lb of the second pressure chamber substrate 51, and thus the cross-sectional area can be reduced. As a result, it is possible to sufficiently remove thickened ink. In addition, the first pressure chamber C1 and the second pressure chamber C2 are formed by using the first portion 52c and the second portion 52d of the first pressure chamber substrate 52 as partition walls, and thus it is possible to reduce the escape of the pressure caused by the piezoelectric element 55 from the first pressure chamber C1 and the second pressure chamber C2.

Each of the first portion 52c and the second portion 52d has a shape extending in the Z1 direction with a constant width when viewed in a cross section (a cross section extending in the X direction and the Z direction when viewed from the Y-axis direction) orthogonal to the Y axis. Therefore, the first portion 52c includes a first wall surface 52c1. The first wall surface 52cl is a surface facing the X1 direction, faces the third portion 52e, and is along the stacking direction. Meanwhile, the second portion 52d has a second wall surface 52d1. The second wall surface 52dl is a surface facing the X2 direction, faces the third portion 52e, and is along the stacking direction. By providing the first wall surface 52cl and the second wall surface 52dl as described above, it is possible to suitably reduce the escape of the pressure caused by the piezoelectric element 55 from the first pressure chamber C1 and the second pressure chamber C2. In the drawing, each of the first wall surface 52cl and the second wall surface 52d1 is a flat surface. However, a shape of each of the first wall surface 52cl and the second wall surface 52dl is not limited to the illustrated example, and may be, for example, a shape curved or bent in a recessed or protruding shape.

Each of the fourth portion 51e and the fifth portion 51f has a shape that extends in the Z2 direction with a constant width when viewed in a cross section orthogonal to the Y axis. Therefore, the fourth portion 51e includes a surface facing the X1 direction, and the fifth portion 51f includes a surface facing the X2 direction, and the surfaces face each other and form wall surfaces of the third pressure chamber C3. Accordingly, the pressure caused by the piezoelectric element 55 can be efficiently transmitted from the third pressure chamber C3 to the nozzle N. Shapes of the surfaces of the fourth portion 51e and the fifth portion 51f forming the wall surfaces of the third pressure chamber C3 are not limited to the illustrated example, and may be, for example, inclined toward the nozzle N, and may be a shape curved or bent in a recessed or protruding shape.

The third portion 52e has a shape in which the width is reduced in the Z1 direction when viewed in a cross section orthogonal to the Y axis. Therefore, the third portion 52e includes a first inclined surface 52e1 and a second inclined surface 52e2. The first inclined surface 52e1 faces the first portion 52c and is inclined toward a X1 direction side with respect to the stacking direction. The second inclined surface 52e2 faces the second portion 52d and is inclined toward a X2 direction side with respect to the stacking direction. By providing the first inclined surface 52e1 and the second inclined surface 52e2 in this manner, the pressure of the liquid can be efficiently transmitted to the nozzle N from both the first pressure chamber C1 and the second pressure chamber C2 via the third pressure chamber C3. In the drawing, each of the first inclined surface 52e1 and the second inclined surface 52e2 is a flat surface. However, a shape of each of the first inclined surface 52e1 and the second inclined surface 52e2 is not limited to the illustrated example, and may be, for example, a shape curved or bent in a recessed or protruding shape. In addition, an inclination angle of each of the first inclined surface 52e1 and the second inclined surface 52e2 is determined according to a length Lc described later, and is, although not particularly limited, preferably 30° or more and 60° or less.

As described above, it is preferable that each of the first portion 52c, the second portion 52d, the fourth portion 51e, and the fifth portion 51f includes a wall surface along the Z-axis direction, and the third portion 52e includes a wall surface inclined with respect to the Z-axis direction. However, the present disclosure is not limited to this configuration as long as the above-described action is not required. For example, the first portion 52c, the second portion 52d, the fourth portion 51e, and the fifth portion 51f may include wall surfaces inclined with respect to the Z-axis direction instead of wall surfaces along the Z-axis direction. For example, the third portion 52e may have a wall surface along the Z axis instead of the wall surface inclined with respect to the Z-axis direction.

As can be seen from FIGS. 5 and 6, the third portion 52e is formed of a member continuous along the Y-axis direction to extend across the plurality of pressure chambers C. In addition, although not illustrated in FIGS. 5 and 6, each of the first portion 52c, the second portion 52d, the fourth portion 51e, and the fifth portion 51f is also formed of a member continuous along the Y-axis direction to extend across the plurality of pressure chambers C.

As illustrated in FIGS. 4 to 6, the first pressure chamber C1 is formed with a space in the first pressure chamber substrate 52, and is partitioned by the first portion 52c and the third portion 52e of the first pressure chamber substrate 52 and the fourth portion 51e of the second pressure chamber substrate 51. Specifically, the first pressure chamber C1 includes the third portion 52e as a wall surface in the X1 direction, the first portion 52c as a wall surface in the X2 direction, and the fourth portion 51e as a wall surface in the Z1 direction.

The second pressure chamber C2 is formed with a space in the first pressure chamber substrate 52, and is partitioned by the second portion 52d and the third portion 52e of the first pressure chamber substrate 52 and the fifth portion 51f of the second pressure chamber substrate 51. Specifically, the second pressure chamber C2 includes the second portion 52d as a wall surface in the X1 direction, the third portion 52e as a wall surface in the X2 direction, and the fifth portion 51f as a wall surface in the Z1 direction.

The third pressure chamber C3 is formed with a space in the second pressure chamber substrate 51, and is partitioned by the third portion 52e of the first pressure chamber substrate 52 and the fourth portion 51e and the fifth portion 51f of the second pressure chamber substrate 51. Specifically, the fifth portion 51f is a wall surface in the X1 direction, the fourth portion 51e is a wall surface in the X2 direction, and the third portion 52e is a wall surface in the Z2 direction.

As illustrated in FIG. 4, it is preferable that a length L3 of the third pressure chamber C3 in the extending direction is shorter than a length L1 of the first pressure chamber C1 in the extending direction and shorter than a length L2 of the second pressure chamber C2 in the extending direction. Accordingly, the pressure of the liquid can be efficiently transmitted to the nozzle N from both the first pressure chamber C1 and the second pressure chamber C2 via the third pressure chamber C3. In addition, displacement of the piezoelectric element 55 can be increased by increasing the length of each of the first pressure chamber C1 and the second pressure chamber C2 in the extending direction. As long as the action is not required, the length L3 of the third pressure chamber C3 in the extending direction may be longer than the length L1 of the first pressure chamber C1 in the extending direction, or may be longer than the length L2 of the second pressure chamber C2 in the extending direction.

In the present embodiment, the length Lc of a lower surface of the third portion 52e in the extending direction is longer than a length Ld of the nozzle N in the extending direction. Accordingly, the cross-sectional area of the flow path from one of the first pressure chamber C1 and the second pressure chamber C2 to the other via a third flow path can be reduced across the entire region directly above the nozzle N.

In the example illustrated in FIG. 4, the thickness Lb of the third pressure chamber C3 along the Z axis is equal to the thickness of the first pressure chamber substrate 52. The thickness Lb is not limited to the illustrated example, and need only be equal to or greater than the thickness of the first pressure chamber substrate 52 and smaller than a total thickness La of the first pressure chamber substrate 52 and the second pressure chamber substrate 51.

It is preferable that a distance Le between the first portion 52c and the fourth portion 51e is shorter than a distance between the third portion 52e and the fourth portion 51e. Accordingly, the pressure in the first pressure chamber C1 caused by the piezoelectric element 55 is less likely to escape to the common discharge flow path 51d. Similarly, it is preferable that a distance Lf between the second portion 52d and the fifth portion 51f is shorter than a distance between the third portion 52e and the fifth portion 51f. Accordingly, the pressure in the second pressure chamber C2 caused by the piezoelectric element 55 is less likely to escape to the common supply flow path 51c.

Hereinafter, an action of the liquid ejection head 50 will be described in comparison with Comparative Examples 1 to 3.

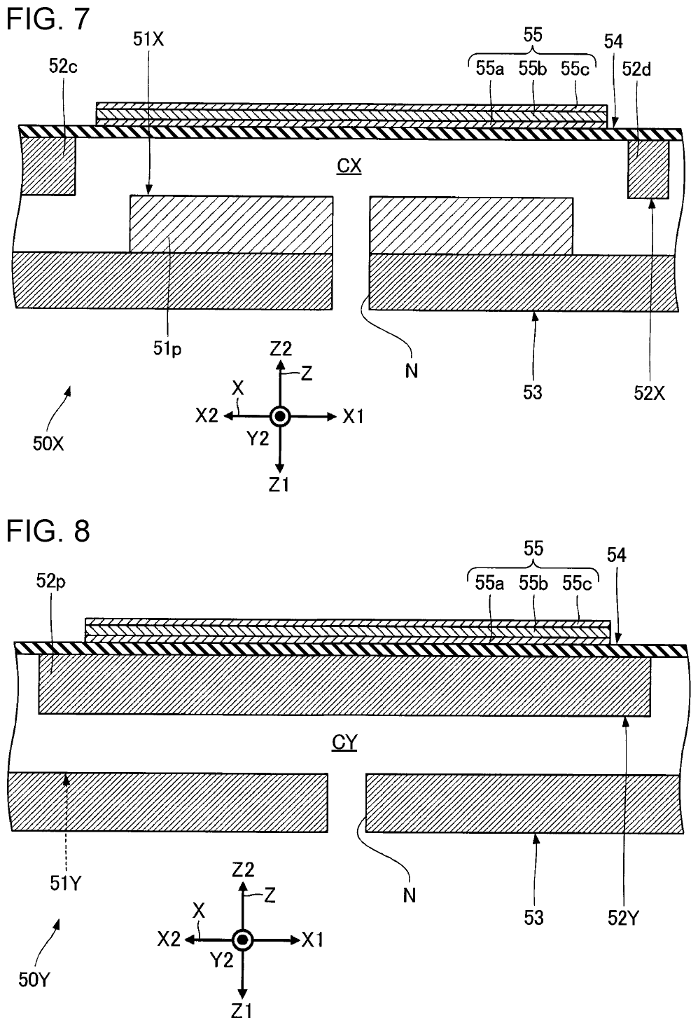

FIG. 7 is an enlarged cross-sectional view illustrating a part of a liquid ejection head 50X of Comparative Example 1. The liquid ejection head 50X is configured in the same manner as the liquid ejection head 50 except that a substrate 52X is provided instead of the first pressure chamber substrate 52 and a substrate 51X is provided instead of the second pressure chamber substrate 51. A thickness of the substrate 52X is also Lb, which is the same as that of the first pressure chamber substrate 52. A thickness of the substrate 51X is also La-Lb, which is the same as that of the second pressure chamber substrate 51.

The substrate 51X is configured in the same manner as the second pressure chamber substrate 51 except that a portion 51p is provided instead of the fourth portion 51e and the fifth portion 51f. The portion 51p extends in the direction along the X axis, and a pressure chamber CX is partitioned by the portion 51p, the first portion 52c, and the second portion 52d. The portion 51p is provided with a through-hole that partitions the nozzle N together with the nozzle substrate 53.

The substrate 52X is configured in the same manner as the first pressure chamber substrate 52 except that the third portion 52e is omitted.

In the liquid ejection head 50X as described above, in a flow path of the circulation by the circulation mechanism 70, a space in the substrate 51X and a space in the substrate 52X are continuous directly above the nozzle N, and a cross-sectional area is locally increased. The cross-sectional area of the flow path referred to in the present comparative example is a cross-sectional area of the flow path directly above the nozzle N when viewed from the X-axis direction, and has widths in the Y-axis direction and the Z-axis direction. That is, since the space in the substrate 52X is also present in addition to the space in the substrate 51X directly above the nozzle N, the width of the flow path in the Z-axis direction in the flow path directly above the nozzle N is the total thickness La of the first pressure chamber substrate 52 and the second pressure chamber substrate 51, and is much larger than that of the flow path directly above the nozzle N in the first embodiment. Therefore, there is a problem that a flow rate is locally decreased and, as a result, the thickened ink is not sufficiently removed. In addition, the pressure applied to the piezoelectric element 55 is likely to escape to both sides of the pressure chamber CX in the extending direction in addition to the nozzle N, and ejection efficiency is not sufficient.

FIG. 8 is an enlarged cross-sectional view illustrating a part of a liquid ejection head 50Y of Comparative Example 2. The liquid ejection head 50Y is configured in the same manner as the liquid ejection head 50 except that a substrate 52Y is provided instead of the first pressure chamber substrate 52 and a substrate 51Y is provided instead of the second pressure chamber substrate 51.

The substrate 51Y is configured in the same manner as the second pressure chamber substrate 51 except that the fourth portion 51e and the fifth portion 51f are omitted.

The substrate 52Y is configured in the same manner as the first pressure chamber substrate 52 except that a portion 52p is provided instead of the first portion 52c, the second portion 52d, and the third portion 52e. The portion 52p extends in the direction along the X axis, and a pressure chamber CY is formed between the portion 52p and the nozzle substrate 53.

It is considered that the pressure chamber CY is formed with a space in the substrate 51Y by leaving the portion 52p of the substrate 52Y directly below the piezoelectric element 55 as in the liquid ejection head 50Y as described above. However, since the cross-sectional area directly above the nozzle N is reduced in this case, although the flow rate decrease can be reduced in the flow path of the circulation by the circulation mechanism 70, the piezoelectric element 55 is covered with the substrate 52Y directly below the piezoelectric element 55. Therefore, even when the piezoelectric element 55 is driven, the vibration of the vibration plate 54 is reduced by the substrate 52Y, and as a result, the ejection characteristics are lowered.

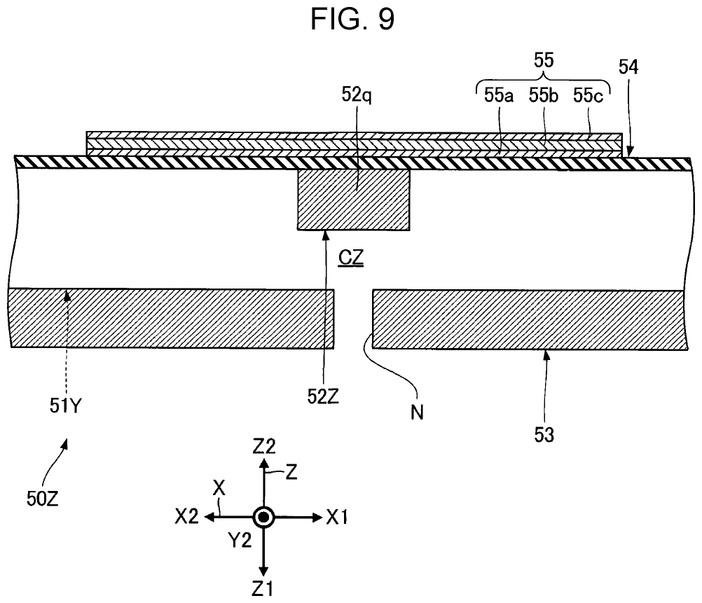

FIG. 9 is an enlarged cross-sectional view illustrating a part of a liquid ejection head 50Z of Comparative Example 3. The liquid ejection head 50Z is configured in the same manner as the liquid ejection head 50 except that a substrate 52Z is provided instead of the first pressure chamber substrate 52 and the substrate 51Y is provided instead of the second pressure chamber substrate 51. The substrate 51Y is the same as that of Comparative Example 2.

The substrate 52Z is configured in the same manner as the first pressure chamber substrate 52 except that a portion 52q is provided instead of the first portion 52c, the second portion 52d, and the third portion 52e. The portion 52q is partially provided only above the nozzle N, and a pressure chamber CZ partitioned by the vibration plate 54, the portion 52q, and the nozzle substrate 53 is formed. That is, the portion 52q corresponds to a portion 52p of Comparative Example 2 in which a length in the direction along the X axis is shortened.

It is considered to provide the portion 52q in which a length in the direction along the X axis is shorter than that of the portion 52p, as in the liquid ejection head 50Z as described above. In this case, since the portion 52q is not provided except for the substrate 52Z, the vibration plate 54 can be suitably vibrated, unlike Comparative Example 2. However, the pressure chamber CZ is largely open except for the left and right central portions in the drawing, and a problem that the pressure when the piezoelectric element 55 is driven is likely to escape to lateral sides of the pressure chamber CZ is not solved, as in Comparative Example 1.

In order to solve the problems of Comparative Examples 1 to 3 described above, the liquid ejection head 50 is provided with the first pressure chamber C1, the second pressure chamber C2, and the third pressure chamber C3 as three divided pressure chambers. In the third pressure chamber C3 that is positioned at the center in the direction along the X axis and communicates with the nozzle N, an upper portion is partitioned by the third portion 52e of the first pressure chamber substrate 52. Therefore, in the flow path of the circulation by the circulation mechanism 70, the cross-sectional area directly above the nozzle N can be reduced. In addition, since the first pressure chamber C1 and the second pressure chamber C2 are formed by partitioning left and right ends of a range in which the piezoelectric element 55 is present with the first portion 52c and the second portion 52d of the first pressure chamber substrate 52 as partition walls, it is possible to reduce the escape of the pressure to lateral sides of the pressure chamber C.

### 2. Second Embodiment

Hereinafter, a second embodiment of the present disclosure will be described. In the embodiment illustrated below, elements having the same effects and functions as those of the first embodiment will be given the reference numerals used in the description of the first embodiment, and each of the detailed descriptions thereof will be appropriately omitted.

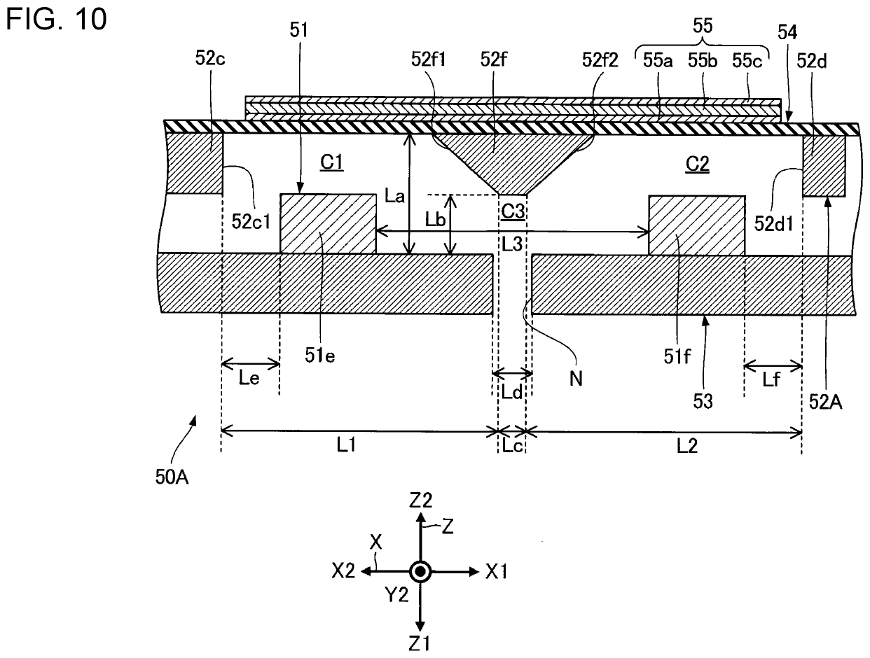

FIG. 10 is an enlarged cross-sectional view illustrating a part of a liquid ejection head 50A according to the second embodiment. The liquid ejection head 50A is configured in the same manner as the liquid ejection head 50 except that a first pressure chamber substrate 52A is provided instead of the first pressure chamber substrate 52. The first pressure chamber substrate 52A is configured in the same manner as the first pressure chamber substrate 52 of the first embodiment, except that a third portion 52f is provided instead of the third portion 52e of the first embodiment.

In the present embodiment, the first pressure chamber C1 is partitioned by the first portion 52c, the third portion 52f, and the fourth portion 51e. The second pressure chamber C2 is partitioned by the second portion 52d, the third portion 52f, and the fifth portion 51f. The third pressure chamber C3 is partitioned by the third portion 52f, the fourth portion 51e, and the fifth portion 51f.

The third portion 52f is configured in the same manner as the third portion 52e of the first embodiment, except that the length Lc is different. Specifically, the third portion 52f has a shape in which the width is reduced in the Z1 direction when viewed in a cross section orthogonal to the Y axis. Therefore, the third portion 52f includes a first inclined surface 52f1 and a second inclined surface 52f2. The first inclined surface 52f1 faces the first portion 52c and is inclined with respect to the stacking direction. The second inclined surface 52f2 faces the second portion 52d and is inclined with respect to the stacking direction. By providing the first inclined surface 52f1 and the second inclined surface 52f2 in this manner, the pressure of the liquid can be efficiently transmitted to the nozzle N from both the first pressure chamber C1 and the second pressure chamber C2 via the third pressure chamber C3. In the drawing, each of the first inclined surface 52f1 and the second inclined surface 52f2 is a flat surface. However, a shape of each of the first inclined surface 52f1 and the second inclined surface 52f2 is not limited to the illustrated example, and may be, for example, a shape curved or bent in a recessed or protruding shape. In addition, an inclination angle of each of the first inclined surface 52f1 and the second inclined surface 52f2 is determined according to the length Lc described later, and is, although not particularly limited, preferably 30° or more and 60° or less.

In the present embodiment, the length Lc of the lower surface of the third portion 52e in the extending direction is shorter than the length of the nozzle N in the extending direction. Accordingly, the pressure of the liquid can be efficiently transmitted to the nozzle N from both the first pressure chamber C1 and the second pressure chamber C2 via the third pressure chamber C3.

According to the second embodiment described above, the thickened ink can be sufficiently removed while the ejection characteristics are excellent.

### 3. Third Embodiment

Hereinafter, a third embodiment of the present disclosure will be described. In the embodiment illustrated below, elements having the same effects and functions as those of the first embodiment will be given the reference numerals used in the description of the first embodiment, and each of the detailed descriptions thereof will be appropriately omitted.

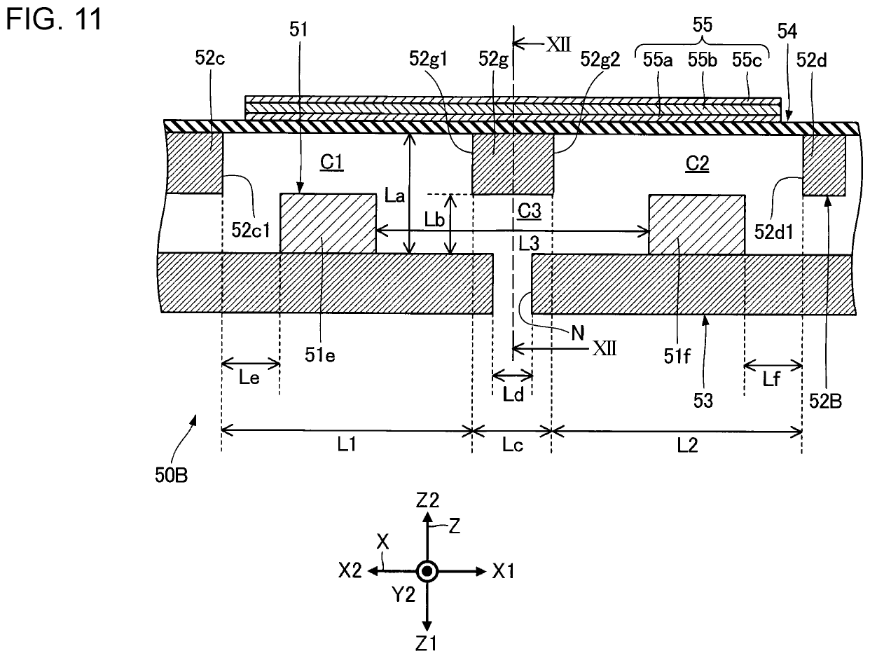

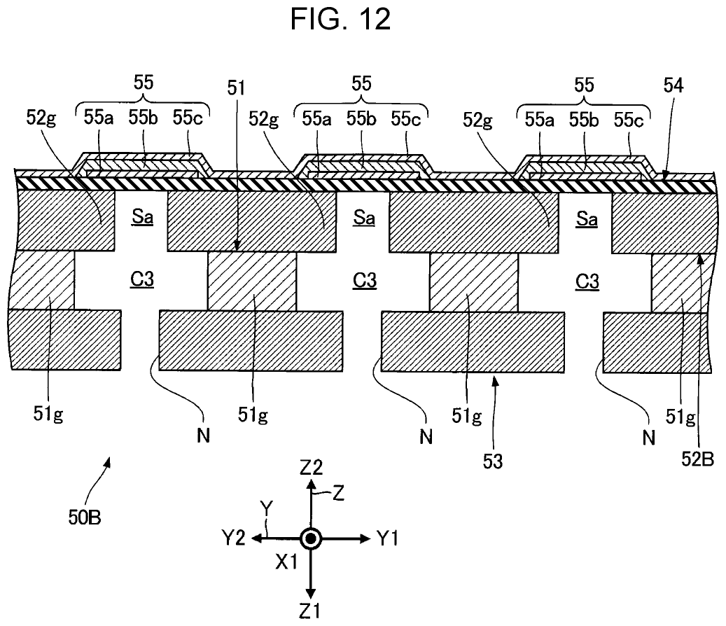

FIG. 11 is an enlarged cross-sectional view illustrating a part of a liquid ejection head 50B according to the third embodiment. FIG. 12 is a cross-sectional view taken along a line XII-XII in FIG. 11. The liquid ejection head 50B is configured in the same manner as the liquid ejection head 50 except that a first pressure chamber substrate 52B is provided instead of the first pressure chamber substrate 52. The first pressure chamber substrate 52B is configured in the same manner as the first pressure chamber substrate 52 of the first embodiment, except that a third portion 52g is provided instead of the third portion 52e of the first embodiment.

In the present embodiment, the first pressure chamber C1 is partitioned by the first portion 52c, the third portion 52g, and the fourth portion 51e. The second pressure chamber C2 is partitioned by the second portion 52d, the third portion 52g, and the fifth portion 51f. The third pressure chamber C3 is partitioned by the third portion 52g, the fourth portion 51e, and the fifth portion 51f.

As illustrated in FIG. 11, the third portion 52g has a shape that extends in the Z1 direction with a constant width when viewed in a cross section orthogonal to the Y axis. Therefore, the third portion 52g includes a wall surface 52g1 and a wall surface 52g2. The wall surface 52g1 is a surface facing the X2 direction, faces the first portion 52c, and is along the stacking direction. The wall surface 52g2 is a surface facing the X1 direction, faces the second portion 52d, and is along the stacking direction. A shape of each of the wall surface 52g1 and the wall surface 52g2 is not limited to the illustrated example, and may be, for example, inclined toward the nozzle N, and may be a shape curved or bent in a recessed or protruding shape.

As illustrated in FIG. 12, a space Sa communicating with the first pressure chamber C1, the second pressure chamber C2, and the third pressure chamber C3 is formed in the third portion 52e. Accordingly, it is possible to reduce flow path resistance of the flow path from one pressure chamber of the first pressure chamber C1 and the second pressure chamber C2 to the other pressure chamber via the third flow path. In the drawing, the space Sa is provided across the entire region of the first pressure chamber substrate 52B in a thickness direction. A shape of the space Sa is not limited to the illustrated example, and may be, for example, a shape smaller than a thickness of the first pressure chamber substrate 52B.

According to the third embodiment described above, the thickened ink can be sufficiently removed while the ejection characteristics are excellent.

### 4. Fourth Embodiment

Hereinafter, a fourth embodiment of the present disclosure will be described. In the embodiment illustrated below, elements having the same effects and functions as those of the first embodiment will be given the reference numerals used in the description of the first embodiment, and each of the detailed descriptions thereof will be appropriately omitted.

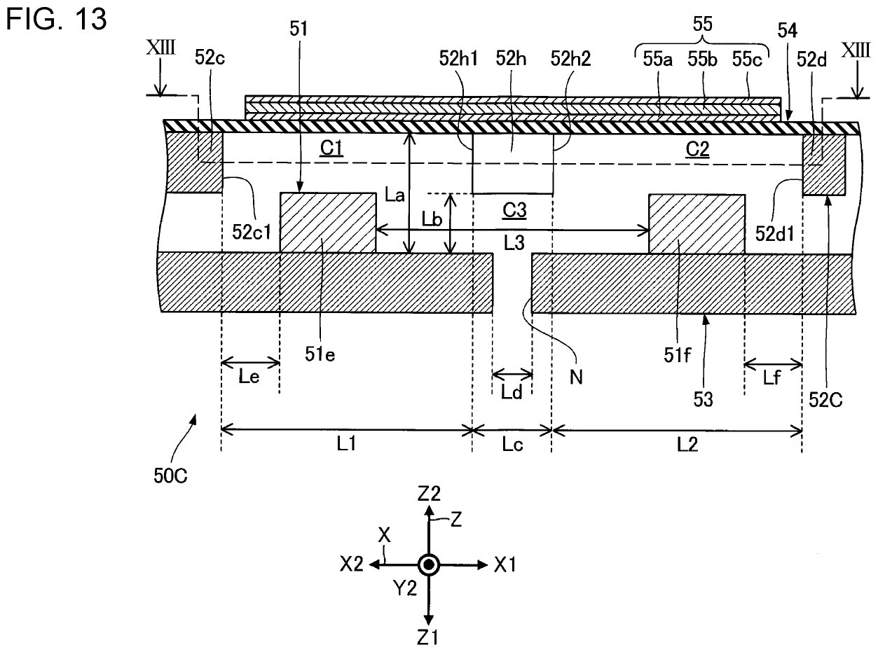

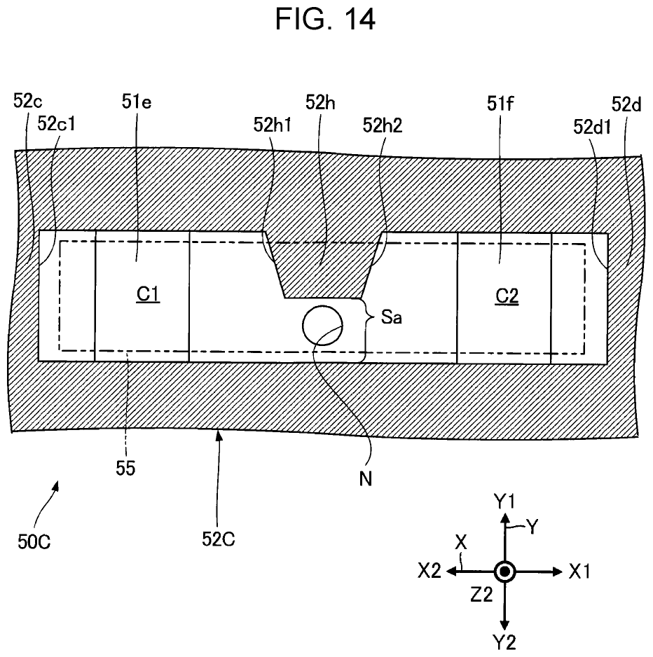

FIG. 13 is an enlarged cross-sectional view illustrating a part of a liquid ejection head 50C according to the fourth embodiment. FIG. 14 is a cross-sectional view taken along a line XIII-XIII in FIG. 13. The liquid ejection head 50C is configured in the same manner as the liquid ejection head 50 except that a first pressure chamber substrate 52C is provided instead of the first pressure chamber substrate 52. The first pressure chamber substrate 52C is configured in the same manner as the first pressure chamber substrate 52 of the first embodiment, except that a third portion 52h is provided instead of the third portion 52e of the first embodiment.

In the present embodiment, the first pressure chamber C1 is partitioned by the first portion 52c, the third portion 52h, and the fourth portion 51e. The second pressure chamber C2 is partitioned by the second portion 52d, the third portion 52h, and the fifth portion 51f. The third pressure chamber C3 is partitioned by the third portion 52h, the fourth portion 51e, and the fifth portion 51f.

As illustrated in FIG. 14, the space Sa communicating with the first pressure chamber C1, the second pressure chamber C2, and the third pressure chamber C3 is formed in the third portion 52h. Accordingly, it is possible to reduce flow path resistance of the flow path from one pressure chamber of the first pressure chamber C1 and the second pressure chamber C2 to the other pressure chamber via the third pressure chamber C3. In the drawing, the space Sa is provided across the entire region of the first pressure chamber substrate 52B in the thickness direction. The shape of the space Sa is not limited to the illustrated example, and may be, for example, a shape smaller than the thickness of the first pressure chamber substrate 52B.

The third portion 52h includes a third inclined surface 52h1 and a fourth inclined surface 52h2. The third inclined surface 52h1 faces the first portion 52c and is inclined with respect to the arrangement direction. The fourth inclined surface 52h2 faces the second portion 52d and is inclined with respect to the arrangement direction. By providing the third inclined surface 52h1 and the fourth inclined surface 52h2 in this manner, a region of the vibration plate 54 deformed by the piezoelectric element 55 can be increased. As a result, an amount of the liquid ejected from the nozzle N can be increased. In addition, it is possible to reduce the flow path resistance of the flow path from one pressure chamber of the first pressure chamber C1 and the second pressure chamber C2 to the other pressure chamber via the third flow path. Furthermore, a crystal plane of silicon can be used to form the third inclined surface 52h1 and the fourth inclined surface 52h2.

Here, as illustrated in FIG. 13, the third portion 52h has a shape that extends in the Z1 direction with a constant width when viewed in a cross section orthogonal to the Y axis. Therefore, the third inclined surface 52h1 faces the first portion 52c and is along the stacking direction. The fourth inclined surface 52h2 faces the second portion 52d and is along the stacking direction. A shape of each of the third inclined surface 52h1 and the fourth inclined surface 52h2 in the cross section orthogonal to the Y axis is not limited to the illustrated example, and may be, for example, inclined toward the nozzle N, and may be a shape curved or bent in a recessed or protruding shape.

According to the fourth embodiment described above, the thickened ink can be sufficiently removed while the ejection characteristics are excellent.

### 5. Modification Example

The embodiments exemplified above can be modified in various ways. Specific modified aspects that may be applied to the above-described embodiments are exemplified below. Any two or more aspects selected from the following examples can be combined as appropriate as long as there is no contradiction.

### 5-1. Modification Example 1

In the above-described embodiment, the serial type liquid ejection device 100 in which the transport body 41 on which the liquid ejection head 50 is mounted is caused to reciprocate in a width direction of the medium M is exemplified, but the liquid ejection device may be a line type liquid ejection device in which the plurality of nozzles N are distributed across the entire width of the medium M.

### 5-2. Modification Example 2

The liquid ejection device described in the above-described embodiment as an example can be adopted not only for an apparatus dedicated to printing but also for various apparatus such as a facsimile device and a copying machine. Note that the application of the liquid ejection device is not limited to printing. For example, a liquid ejection device that ejects a solution of a coloring material is used as a manufacturing device that forms a color filter of a display device such as a liquid crystal display panel. In addition, a liquid ejection device that ejects a solution of a conductive material is used as a manufacturing device that forms wiring or an electrode of a wiring substrate. In addition, a liquid ejection device that ejects a solution of an organic substance related to a living body is used as a manufacturing device that manufactures a biochip, for example.

What is claimed is:

1. A liquid ejection head comprising:
a piezoelectric element;
a vibration plate that vibrates through driving of the piezoelectric element;
a first pressure chamber substrate;
a second pressure chamber substrate; and
a nozzle substrate provided with a nozzle that ejects a liquid,
the piezoelectric element, the vibration plate, the first pressure chamber substrate, the second pressure chamber substrate, and the nozzle substrate being stacked in a stacking direction from top to bottom in an order of the piezoelectric element, the vibration plate, the first pressure chamber substrate, the second pressure chamber substrate, and the nozzle substrate, wherein
the first pressure chamber substrate includes a first portion, a second portion separated from the first portion, a third portion separated from the first portion and the second portion and positioned between the first portion and the second portion,
the second pressure chamber substrate includes a fourth portion and a fifth portion separated from the fourth portion,
the first pressure chamber substrate is provided with
a first pressure chamber formed with a space inside the first pressure chamber substrate and partitioned by the first portion, the third portion, and the fourth portion, and
a second pressure chamber formed with a space inside the first pressure chamber substrate and partitioned by the second portion, the third portion, and the fifth portion,
the second pressure chamber substrate is provided with
a third pressure chamber formed with a space inside the second pressure chamber substrate, partitioned by the third portion, the fourth portion, the fifth portion, and communicating with the first pressure chamber, the second pressure chamber, and the nozzle, and
the piezoelectric element is commonly disposed across the first pressure chamber, the second pressure chamber, and the third pressure chamber.

2. The liquid ejection head according to claim 1, wherein
each of the first pressure chamber, the second pressure chamber, and the third pressure chamber extends in an extending direction, and
a plurality of sets of the first pressure chamber, the second pressure chamber, and the third pressure chamber are arranged in an arrangement direction intersecting with the extending direction.

3. The liquid ejection head according to claim 2, further comprising:
a common supply flow path through which the liquid is commonly supplied to the plurality of sets; and
a common discharge flow path through which the liquid is commonly discharged from the plurality of sets.

4. The liquid ejection head according to claim 2, wherein
a length of the third pressure chamber in the extending direction is shorter than a length of the first pressure chamber in the extending direction and is shorter than a length of the second pressure chamber in the extending direction.

5. The liquid ejection head according to claim 2, wherein
a length of a lower surface of the third portion in the extending direction is longer than a length of the nozzle in the extending direction.

6. The liquid ejection head according to claim 2, wherein
a length of a lower surface of the third portion in the extending direction is shorter than a length of the nozzle in the extending direction.

7. The liquid ejection head according to claim 2, wherein
the third portion includes
a first inclined surface that faces the first portion and is inclined with respect to the stacking direction, and
a second inclined surface that faces the second portion and is inclined with respect to the stacking direction.

8. The liquid ejection head according to claim 7, wherein
the first portion includes a first wall surface that faces the third portion and is along the stacking direction, and
the second portion includes a second wall surface that faces the third portion and is along the stacking direction.

9. The liquid ejection head according to claim 2, wherein
the third portion includes
a third inclined surface that faces the first portion and is inclined with respect to the arrangement direction, and
a fourth inclined surface that faces the second portion and is inclined with respect to the arrangement direction.

10. The liquid ejection head according to claim 2, wherein
a space communicating with the first pressure chamber, the second pressure chamber, and the third pressure chamber is formed in the third portion.

11. The liquid ejection head according to claim 2, further comprising:
a first absorption chamber that communicates with the first pressure chamber and absorbs a pressure caused by the piezoelectric element; and
a second absorption chamber that communicates with the second pressure chamber and absorbs a pressure caused by the piezoelectric element.

12. The liquid ejection head according to claim 11, wherein
a first absorption member formed of the same material as at least a part of the vibration plate and the piezoelectric element is provided above the first absorption chamber, and
a second absorption member formed of the same material as at least a part of the vibration plate and the piezoelectric element is provided above the second absorption chamber.

13. The liquid ejection head according to claim 11, wherein
the first absorption chamber is formed with a space inside the first pressure chamber substrate and a space inside the second pressure chamber substrate, and
the second absorption chamber is formed with a space inside the first pressure chamber substrate and a space inside the second pressure chamber substrate.

14. A liquid ejection device comprising:
the liquid ejection head according to claim 2; and
a control section that controls an ejection operation of the liquid ejection head.
